(19) United States
(12) Patent Application Publication
(10) Pub. No.: US 2017/0295516 A1
(43) Pub. Date: Oct. 12, 2017

(54) DYNAMIC MEDIUM ACCESS CONTROL RECEPTION-REORDER TIMEOUT IN A CROWDED WIRELESS LOCAL AREA NETWORK

(71) Applicant: QUALCOMM Incorporated, San Diego, CA (US)

(72) Inventors: Qinghai Gao, Sunnyvale, CA (US); Nathaniel David Houghton, San Jose, CA (US); Ehab Tahir, Mississauga (CA)

(21) Appl. No.: 15/094,677

(22) Filed: Apr. 8, 2016

(51) Int. Cl. H04W 28/06; H04W 24/04

(52) U.S. Cl. CPC H04W 28/065; H04W 24/04; H04W 84/12

(57) ABSTRACT

Methods, systems, and devices for wireless communication are described. A device may identify an indication of a station load in a wireless local area network (WLAN) and estimate a delay to fill a packet hole at the medium access control (MAC) layer based on the station load. The estimated time period may be used to adjust a reorder timeout value. In some cases the reorder timeout value may be increased when the station load is high to reduce the likelihood that packet holes will be flushed to higher layers before the device is served with the missing packets. In some cases, the station load may be determined based on a message received from a serving access point (AP).

### BACKGROUND

The following relates generally to wireless communication, and more specifically to dynamic medium access control (MAC) reception reorder timeout in a crowded wireless local area network (WLAN).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a wireless fidelity (Wi-Fi) (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

In a crowded environment, it may take longer for a client to be served after requesting and waiting for missing data. In some cases this may result in lost packets. For example, a reception reorder timeout may determine the time duration before a device pushes received data packets to an upper stack (e.g., Transmission Control Protocol (TCP) stack) when there is a hole (e.g., missing packet) in a list of sequence numbers. If an AP is serving a large number of clients, the reorder timeout value may expire before a station is served with a missing packet. Flushing the data before the device is served with the missing packets may result in a delays or degraded communication quality.

### SUMMARY

A device may identify an indication of a station load in a wireless local area network (WLAN) and estimate a delay to fill a packet hole at the medium access control (MAC) layer based on the station load. The estimated time period may be used to adjust a reorder timeout value. In some cases the reorder timeout value may be increased when the station load is high to reduce the likelihood that packet holes will be flushed to higher layers before the device is served with the missing packets. In some cases, the station load may be determined based on a message received from a serving access point (AP).

A method of wireless communication is described. The method may include identifying an indication of a station load in a WLAN, estimating a delay to fill a packet hole at a MAC layer based at least in part on the indication, wherein a packet hole corresponds to a hole in a list of sequence numbers, and adjusting a reorder timeout value according to the estimated delay.

An apparatus for wireless communication is described. The apparatus may include means for identifying an indication of a station load in a WLAN, means for estimating a delay to fill a packet hole at a MAC layer based at least in part on the indication, wherein a packet hole corresponds to a hole in a list of sequence numbers, and means for adjusting a reorder timeout value according to the estimated delay.

A further apparatus is described. The apparatus may include a processor, memory in electronic communication with the processor, and instructions stored in the memory. The instructions may be operable to cause the processor to identify an indication of a station load in a WLAN, estimate a delay to fill a packet hole at a MAC layer based at least in part on the indication, wherein a packet hole corresponds to a hole in a list of sequence numbers, and adjust a reorder timeout value according to the estimated delay.

A non-transitory computer readable medium for wireless communication is described. The non-transitory computer-readable medium may include instructions to cause a processor to identify an indication of a station load in a WLAN, estimate a delay to fill a packet hole at a MAC layer based on the indication and adjust a reorder timeout value according to the estimated delay.

Some examples of the method, apparatus, or non-transitory computer-readable medium described above may further include processes, features, means, or instructions for identifying an expected packet that has not been received, where the packet hole is based on the expected packet. Some examples may further include determining that a timer has expired based on the reorder timeout value. Some examples may further include flushing a set of buffered packets and the packet hole to a higher layer based on the determination.

Some examples of the method, apparatus, or non-transitory computer-readable medium described above may further include processes, features, means, or instructions for determining that a number of bursts received following the packet hole is greater than a threshold, where flushing the set of buffered packets and the packet hole is based on the determination that the number of bursts received following the packet hole is greater than the threshold. Some examples may further include determining an average time to fill the packet hole for a traffic identifier (TID). Some examples may further include determining a deviation time to fill the packet hole based on the average time, where adjusting the reorder timeout value is based on the average time and the deviation time.

Some examples of the method, apparatus, or non-transitory computer-readable medium described above may further include processes, features, means, or instructions for identifying a minimum value and a maximum value, where adjusting the reorder timeout value is based on the minimum value or the maximum value. Some examples may further identifying an access category, where the reorder timeout value is based on the access category.

In some examples of the method, apparatus, or non-transitory computer-readable medium described above, adjusting the reorder timeout value comprises: increasing the reorder timeout value if the station load is above a threshold or decreasing the reorder timeout value if the station load is below the threshold. There may be one or more thresholds associated with the adjusting of the reorder timeout value. Some examples may further include receiving a message from an AP, the message comprising the indication of the station load.

### BRIEF DESCRIPTION OF THE DRAWINGS

FIG. 1 illustrates an example of a wireless communications system that supports dynamic medium access control reception-reorder timeout in a crowded wireless local area network in accordance with aspects of the present disclosure;

FIG. 2 illustrates an example of a process flow in a system that supports dynamic medium access control reception-reorder timeout in a crowded wireless local area network in accordance with aspects of the present disclosure;

FIGS. 3 through 5 show block diagrams of a wireless device that supports dynamic medium access control reception-reorder timeout in a crowded wireless local area network in accordance with aspects of the present disclosure;

FIG. 6 illustrates a block diagram of a system including a station (STA) that supports dynamic medium access control reception-reorder timeout in a crowded wireless local area network in accordance with aspects of the present disclosure; and

FIGS. 7 through 10 illustrate methods for dynamic medium access control reception-reorder timeout in a crowded wireless local area network in accordance with aspects of the present disclosure.

### DETAILED DESCRIPTION

Crowded wireless local area networks (WLANs) may experience an increased number of lost data packets. For example, in a multi-client environment, it may take longer for a client to be served again when requesting and waiting for missing data. A crowded WLAN may be defined as a WLAN that includes either stations (STAs) and/or access points (APs) that develop a backlog of data due to waiting for other devices (e.g., other STAs or APs) in a basic service set (BSS). A reception reorder timeout may determine the time duration before a Media Access Control (MAC) layer pushes received data packets to an upper stack (e.g., Transmission Control Protocol (TCP) stack) when there is a hole (e.g., a missing sequence number in a list of packet sequence numbers) that corresponds to a missing packet.

According to the present disclosure, the reception reorder timeout may be set based on the number of STAs in the WLAN. For example, an access point AP may identify a number of stations parameter (e.g., a station load) based on traffic activity. The AP may convey the station load to the STAs using message passing. The STA may then dynamically adjust its reception reorder timeout value accordingly. In some examples, the greater the station load the greater timeout value that is selected.

Aspects of the disclosure are initially described in the context of a wireless communication system. A specific example is then described for dynamically adjusting reception reorder timeouts at the MAC level. Aspects of the disclosure are further illustrated by and described with reference to apparatus diagrams, system diagrams, and flowcharts that relate to dynamic MAC reception reorder timeout in a crowded WLAN.

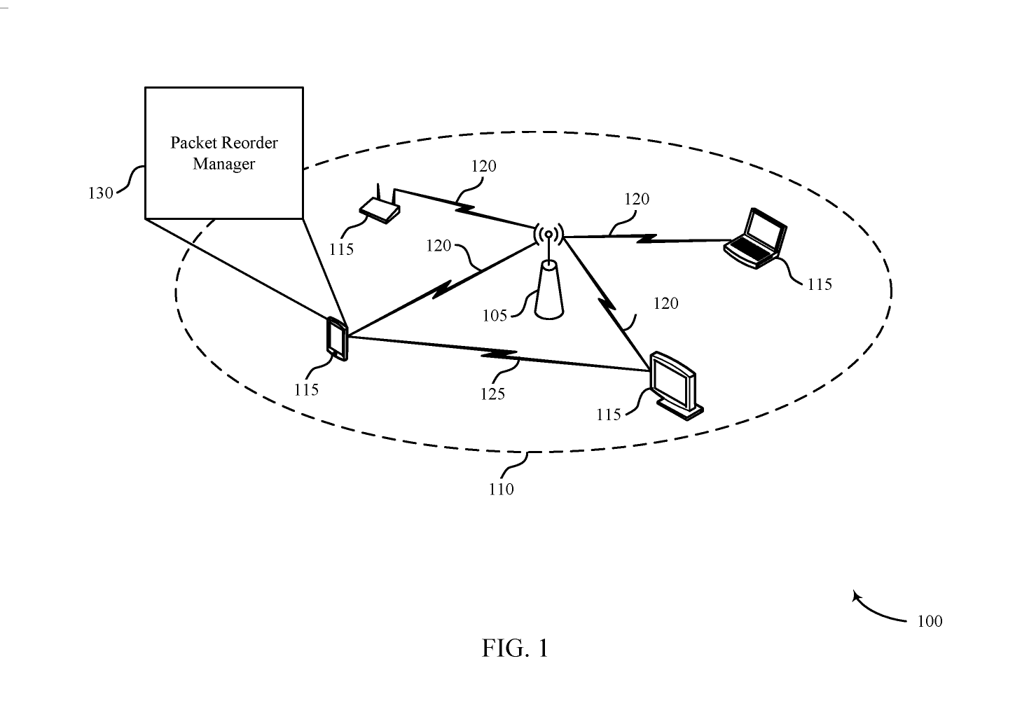

FIG. 1 illustrates a wireless local area network (WLAN) 100 (also known as a wireless fidelity (Wi-Fi) network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. In some cases, a STA may act as an AP if configured as a SoftAP. SoftAP may refer to a STA with software enabling the STA that has not been specifically made to be a router to act as a wireless AP or virtual router. One or more of the STAs 115 may include a packet reorder manager 130, which may enable the STA 115 to dynamically adjust a packet reorder timeout value based on parameters such as a traffic load for a serving AP 105. In some cases, a STA 115 that includes a packet reorder manager 130 may be a SoftAP.

The AP 105 and the associated STAs 115 may represent a BSS or an extended service set (ESS). The various STAs 115 in the network are able to communicate with one another through the AP 105. Also shown is a coverage area 110 of the AP 105, which may represent a BSS of the WLAN 100. An extended network station (not shown) associated with the WLAN 100 may be connected to a wired or wireless distribution system that may allow multiple APs 105 to be connected in an ESS. A reception reorder timeout may be set based on the number of STAs 115 in the multi-client WLAN 100.

The AP 105 may identify a number of stations parameter (e.g., a station load) based on activity of direct wireless links 120 within the coverage area 110. The AP 105 may then convey the station load to the STAs 115. In one example, STA 115-a may dynamically adjust the reception reorder timeout value as a function of the station load. In some cases, the greater the station load the greater the reorder timeout value that may be selected. In other examples, the maximum timeout value and the minimum timeout value may be a function of the station load.

In some cases, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. The coverage area 110 of an AP 105 may also be divided into sectors (also not shown). The WLAN 100 may include APs 105 of different types (e.g., metropolitan area, home network, etc.), with varying and overlapping coverage areas 110. Two STAs 115 may also communicate directly via a device to device (D2D) direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to a WLAN radio and baseband protocol for physical and MAC.

In some cases, an AP 105 may serve a large number of STAs 115. A crowded WLAN system may experience an increased number of lost data packets. For example, it may take longer for a STA 115 to be served again when requesting and waiting for missing data. A reception reorder timeout may determine the time duration before a Media Access Control (MAC) layer of a STA 115 pushes received data packets to an upper stack (e.g., Transmission Control Protocol (TCP) stack) when there is a hole (e.g., missing packet) in sequence numbers.

In some cases (e.g., in a multi-client environment), a reception reorder timeout may be set to, e.g., 100 ms. Other values may also be used. Packets containing holes may be flushed up to a TCP stack after waiting for this period. In WLAN systems with multiple clients, a round trip time may be longer than this time period and may require a longer reception reorder timeout. Thus, any nonzero packet error rate (PER) in a physical layer convergence protocol (PLCP) protocol data unit (PPDU) may lead to flushing of a data packet sequence containing holes. TCP may keep sending negative acknowledgements (NACKs) asking for a missing data packet, but may not receive them prior to the timeout period. This may result in packet loss and reduced connection quality.

Thus, use of a dynamic reception reorder timeout at the MAC level may increase throughput. In some cases, a timeout value may be increased to a large value (e.g., 2 s) regardless of how many UEs are in the WLAN. That is, a receiver may flush packets with holes after receiving a threshold number (e.g., n=2) of extra bursts.

In some cases, a maximum timeout value and a minimum timeout value may be set. Timeout settings may be tuned based on the access category (e.g., 20 ms or less for voice (VO), 200 ms for video (VI), and a value in the seconds range for best effort (BE) packets). In some cases a device may set the reorder timeout value by maintain a running average time to fill a hole and according to the following equation:

$$Avg\_T \_fill \_new = ( \frac{7}{8} ) Avg\_T \_fill \_old + ( \frac{1}{8} ) T , \qquad ( 1 )$$

where Avg_T_fill_new is an updated average time to fill a packet, vg_T_fill_old is a previous average, and T is a recent measurement of a time to fill a packet.

In some cases, the receiver may also track the deviation from the average time to fill a hole and use a deviation parameter to set the reorder timeout value:

$$Avg\_T \_fill \_new = ( \frac{7}{8} ) Dev\_T \_fill \_old + ( \frac{1}{8} ) \vert T - Avg\_T \_fill \vert , \qquad ( 2 )$$

where Dev_T_fill_new is the current deviation, Dev_T_fill_old is the previous deviation.

The re-reorder timeout value may be set using a combination of average and deviation parameters (where the deviation is scaled by load factor α that may depend on the station load):

Rx_reorder_timeout=Avg_T_fill+α*Dev_T_fill. (3)

Thus, the reception reorder timeout may be set based on the number of stations STAs 115 in the WLAN. In some cases, the AP 105 may identify the station load based on traffic activities over the air. The AP may convey the station load to the STAs using message passing. The STA 115 may dynamically adjust its reception reorder timeout value (e.g., by making a α function of the station load). In some examples, the greater the station load the greater the α that may be selected. In other examples, a maximum timeout value or a minimum timeout value may be a function of the station load.

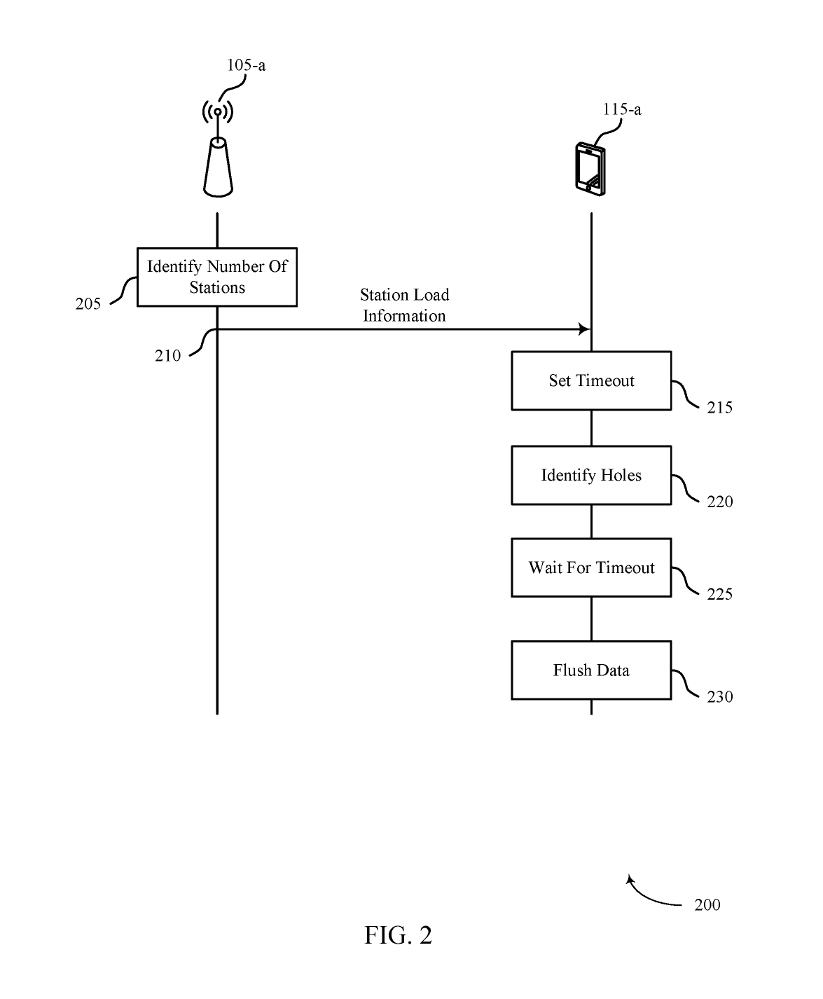

FIG. 2 illustrates an example of a process flow 200 that supports dynamic MAC reception reorder timeout in a crowded wireless local area network in accordance with various aspects of the present disclosure. Process flow 200 may include AP 105-a and STA 115-a which may be examples of the corresponding devices described with reference to FIG. 1-0.

At step 205, AP 105-a may identify the number of stations in the network. For example, AP 105-a may determine a number of stations in a BSS or determine a level of traffic activity.

At step 210, AP 105-a may transmit the station load to STA 115-a. STA 115-a may receive the message including the indication of the station load from AP 105-a. The indication of station load in a WLAN may be used to estimate a delay to fill a packet hole at a MAC layer. Thus, an average time to fill a packet hole for a traffic identifier (TID) may be identified. Further, a deviation time to fill the packet hole may be determined based on the average time.

At step 215, STA 115-a may set a timeout. In some cases, the reorder timeout value may be adjusted according to the estimated delay to fill a packet hole. In some cases, the reorder timeout value may be adjusted according to the average time and deviation time. In some cases, an identified access category may be used to adjust the reorder timeout. In some cases, a reorder timeout may be adjusted based on a minimum value and a maximum value.

For example, the reorder timeout value may be increased if the reorder timeout value (or the station load) is above a threshold or may be decreased if the reorder timeout value (or the station load) is below the threshold. There may be one or more thresholds associated with the adjusting of the reorder timeout value.

At step 220, STA 115-a may identify holes in a data packet sequence. For example, the identified packet hole may be based on an expected packet that has not been received. At step 225, STA 115-a may wait for the determined timeout period. For example, determination of a timer expiration may be based on the reorder timeout value.

At step 230, STA 115-a may flush the data to higher layers (e.g., higher than the MAC layer). In some cases, flushing a set of buffered packets and the packet hole to a higher layer may be based on the timer expiration. In other cases, the flushing may be based on a determination that a number of received bursts following the packet hole exceeds a threshold.

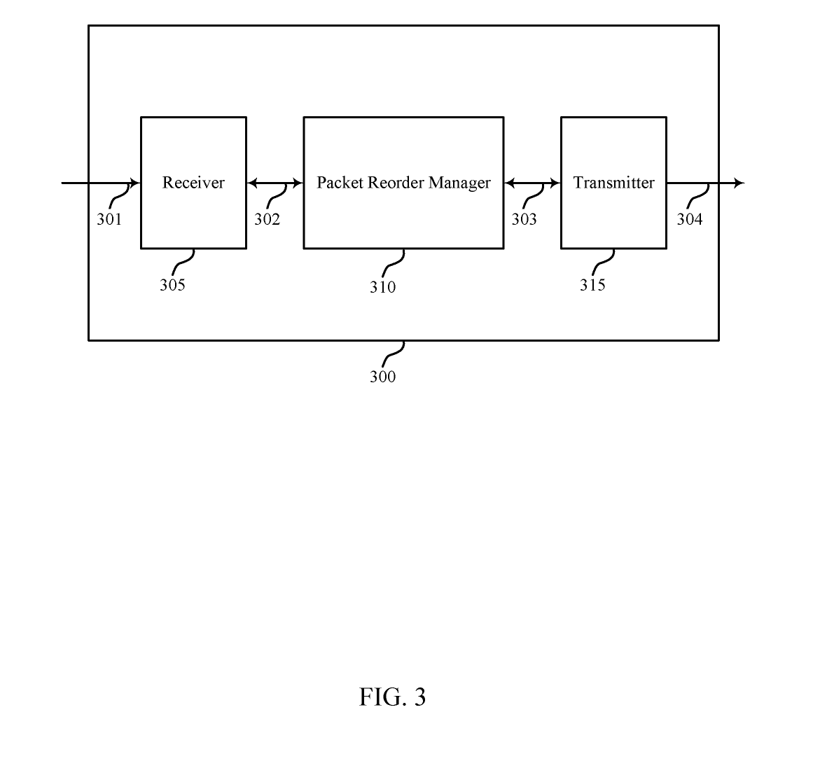

FIG. 3 shows a block diagram of a wireless device 300 that supports dynamic MAC reception reorder timeout in a crowded WLAN in accordance with various aspects of the present disclosure. Wireless device 300 may be an example of aspects of a STA 115 or AP 105 described with reference to FIGS. 1 and 2. Wireless device 300 may include receiver 305, packet reorder manager 310 and transmitter 315. Wireless device 300 may also include a processor. Each of these components may be in communication with each other (e.g., via signals 301, 302, 303, and 304). In one example, the components of wireless device 300 may each include a circuit or circuitry for accomplishing the functions described below.

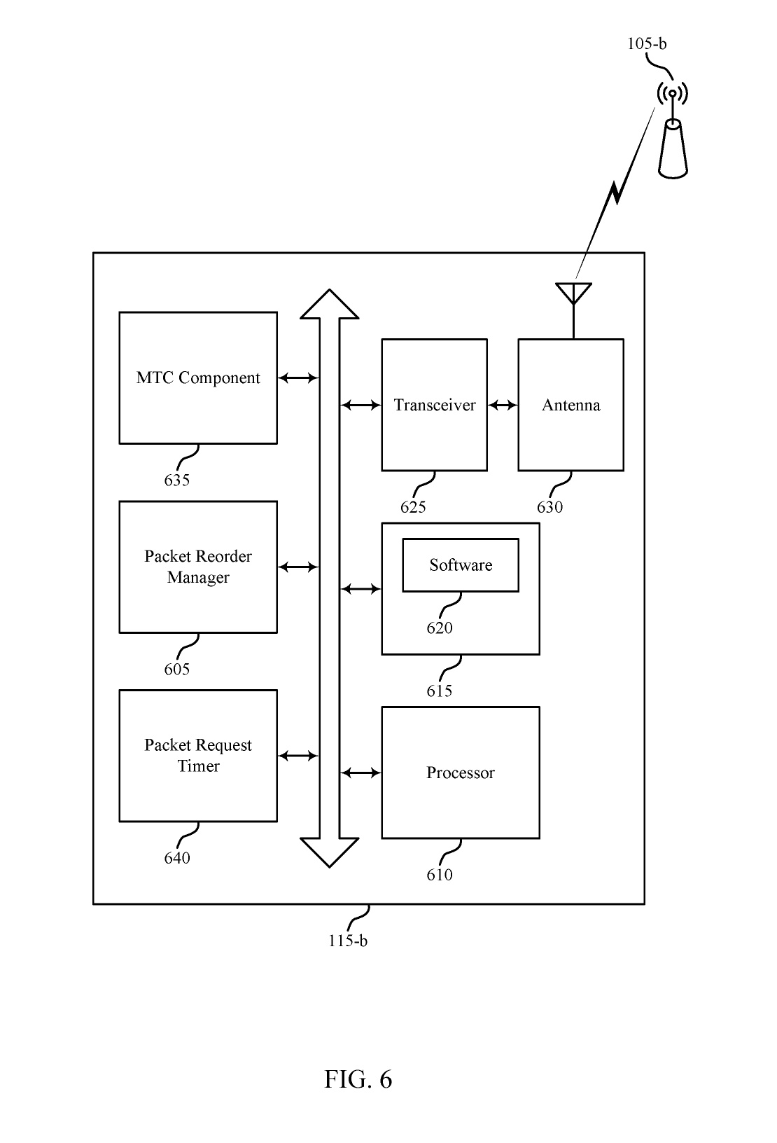

The receiver 305 may receive information such as packets, user data, or control information associated with various information channels (e.g., control channels, data channels, and information related to dynamic MAC reception reorder timeout in a crowded WLAN, etc.). Information may be passed on to other components of the device. The receiver 305 may be an example of aspects of the transceiver 625 described with reference to FIG. 6.

The packet reorder manager 310 may identify an indication of a station load in a WLAN, estimate a delay to fill a packet hole at a MAC layer based on the indication, and adjust a reorder timeout value according to the estimated delay. The packet reorder manager 310 may also be an example of aspects of the packet reorder manager 605 described with reference to FIG. 6.

The transmitter 315 may transmit signals received from other components of wireless device 300. In some examples, the transmitter 315 may be collocated with a receiver in a transmitter. For example, the transmitter 315 may be an example of aspects of the transceiver 625 described with reference to FIG. 6. The transmitter 315 may include a single antenna, or it may include a plurality of antennas.

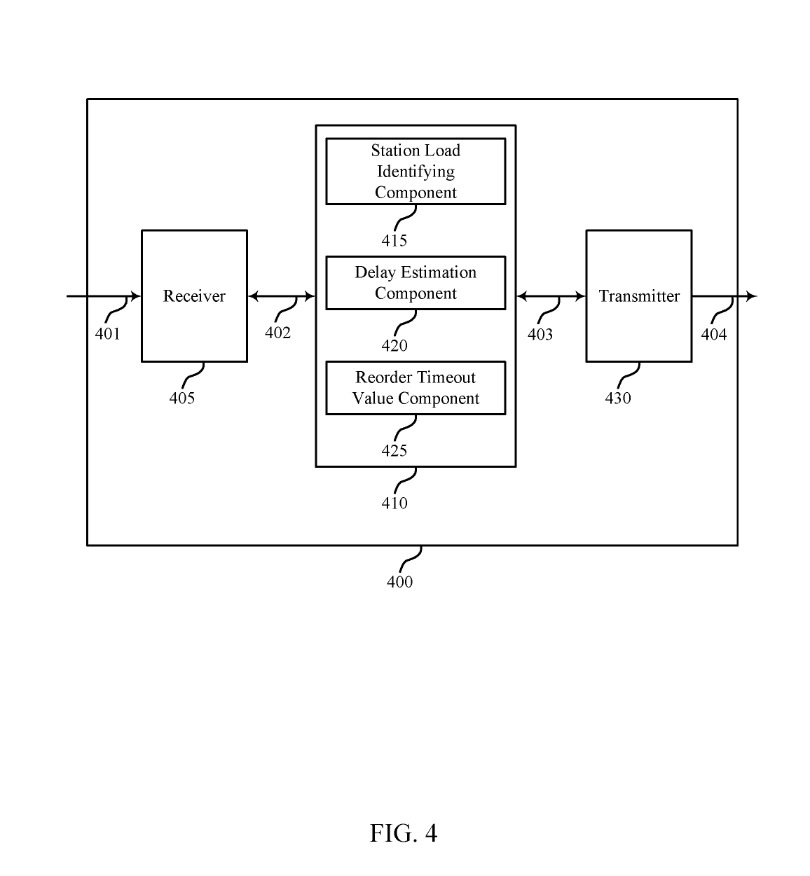

FIG. 4 shows a block diagram of a wireless device 400 that supports dynamic MAC reception reorder timeout in a crowded WLAN in accordance with various aspects of the present disclosure. Wireless device 400 may be an example of aspects of a wireless device 300 or a STA 115 or AP 105 described with reference to FIGS. 1, 2 and 3. Wireless device 400 may include receiver 405, packet reorder manager 410 and transmitter 430. Wireless device 400 may also include a processor. Each of these components may be in communication with each other (e.g., via signals 401, 402, 403, and 404). Each of these components may be in communication with each other. In one example, the components of wireless device 400 may each include a circuit or circuitry for accomplishing the functions described below.

The receiver 405 may receive information which may be passed on to other components of the device. The receiver 405 may also perform the functions described with reference to the receiver 305 of FIG. 3. The receiver 405 may be an example of aspects of the transceiver 625 described with reference to FIG. 6.

The packet reorder manager 410 may be an example of aspects of packet reorder manager 310 described with reference to FIG. 3. The packet reorder manager 410 may include station load identifying component 415, delay estimation component 420 and reorder timeout value component 425. The packet reorder manager 410 may be an example of aspects of the packet reorder manager 605 described with reference to FIG. 6. The station load identifying component 415 may receive a message from an AP, the message including the indication of the station load, and identify an indication of a station load in a WLAN.

The delay estimation component 420 may determine an average time to fill the packet hole for a traffic identifier (TID), determine a deviation time to fill the packet hole based on the average time, where adjusting the reorder timeout value is based on the average time and the deviation time, identify a minimum value and a maximum value, where adjusting the reorder timeout value is based on the minimum value or the maximum value, and estimate a delay to fill a packet hole at a MAC layer based on the indication.

The reorder timeout value component 425 may identify an access category, where the reorder timeout value is based on the access category, adjust a reorder timeout value according to the estimated delay, and determine that a timer has expired based on the reorder timeout value. In some cases, adjusting the reorder timeout value includes: increasing the reorder timeout value if the station load is above a threshold or decreasing the reorder timeout value if the station load is below the threshold. There may be one or more thresholds associated with the adjusting of the reorder timeout value.

The transmitter 430 may transmit signals received from other components of wireless device 400. In some examples, the transmitter 430 may be collocated with a receiver in a transmitter. For example, the transmitter 430 may be an example of aspects of the transceiver 625 described with reference to FIG. 6. The transmitter 430 may utilize a single antenna, or it may utilize a plurality of antennas.

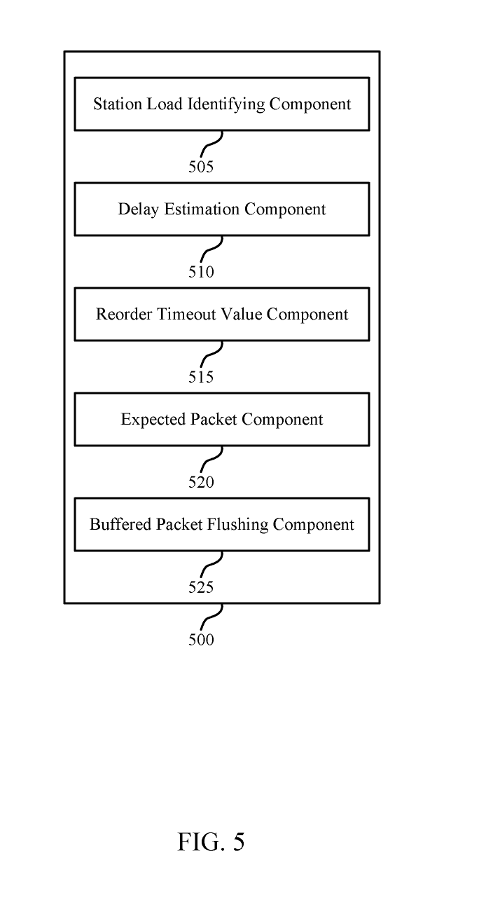

FIG. 5 shows a block diagram of a packet reorder manager 500 which may be an example of the corresponding component of wireless device 300 or wireless device 400. That is, packet reorder manager 500 may be an example of aspects of packet reorder manager 310 or packet reorder manager 410 described with reference to FIGS. 3 and 4. The packet reorder manager 500 may also be an example of aspects of the packet reorder manager 605 described with reference to FIG. 6. Each of these components may be in communication with each other. In one example, the components of packet reorder manager 500 may each include a circuit or circuitry for accomplishing the functions described below.

The packet reorder manager 500 may include station load identifying component 505, delay estimation component 510, reorder timeout value component 515, expected packet component 520 and buffered packet flushing component 525. Each of these components may communicate, directly or indirectly, with one another (e.g., via one or more buses). The station load identifying component 505 may receive a message from an AP, the message including the indication of the station load, and identify an indication of a station load in a WLAN.

The delay estimation component 510 may determine an average time to fill the packet hole for a traffic identifier (TID), determine a deviation time to fill the packet hole based on the average time, where adjusting the reorder timeout value is based on the average time and the deviation time, identify a minimum value and a maximum value, where adjusting the reorder timeout value is based on the minimum value or the maximum value, and estimate a delay to fill a packet hole at a MAC layer based on the indication.

The reorder timeout value component 515 may identify an access category, where the reorder timeout value is based on the access category, adjust a reorder timeout value according to the estimated delay, and determine that a timer has expired based on the reorder timeout value. In some cases, adjusting the reorder timeout value includes: increasing the reorder timeout value if the station load is above a threshold or decreasing the reorder timeout value if the station load is below the threshold. There may be one or more thresholds associated with the adjusting of the reorder timeout value.

The expected packet component 520 may identify an expected packet that has not been received, where the packet hole is based on the expected packet. The buffered packet flushing component 525 may flush a set of buffered packets and the packet hole to a higher layer based on the determination, and determine that a number of bursts received following the packet hole is greater than a threshold, where flushing the set of buffered packets and the packet hole is based on the determination that the number of bursts received following the packet hole is greater than the threshold.

FIG. 6 shows a diagram of a system 600 including a device that supports dynamic MAC reception reorder timeout in a crowded WLAN in accordance with various aspects of the present disclosure. For example, system 600 may include STA 115-b, which may be an example of a wireless device 300, a wireless device 400, or a STA 115 as described with reference to FIGS. 1, 2 and 3 through 5. In one example, the components of STA 115-b may each include a circuit or circuitry for accomplishing the functions described below.

STA 115-b may also include packet reorder manager 605, processor 610, memory 615, transceiver 625, antenna 630, packet request timer 640 and, in some cases, machine-type communication (MTC) component 635. Each of these components may communicate, directly or indirectly, with one another (e.g., via one or more buses). The packet reorder manager 605 may be an example of a packet reorder manager as described with reference to FIGS. 3 through 5. Packet reorder manager 605 may perform reordering of packets based on a packet request timer 640. The processor 610 may include an intelligent hardware device, (e.g., a central processing unit (CPU), a microcontroller, an application specific integrated circuit (ASIC), etc.)

The memory 615 may include random access memory (RAM) and read only memory (ROM). The memory 615 may store computer-readable, computer-executable software including instructions that, when executed, cause the processor to perform various functions described herein (e.g., dynamic MAC reception reorder timeout in a crowded WLAN, etc.). In some cases, the software 620 may not be directly executable by the processor but may cause a computer (e.g., when compiled and executed) to perform functions described herein.

The transceiver 625 may communicate bi-directionally, via one or more antennas, wired, or wireless links, with one or more networks, as described above. For example, the transceiver 625 may communicate bi-directionally with an AP 105 or a STA 115. The transceiver 625 may also include a modem to modulate the packets and provide the modulated packets to the antennas for transmission, and to demodulate packets received from the antennas. In some cases, the wireless device may include a single antenna 630. However, in some cases the device may have more than one antenna 630, which may be capable of concurrently transmitting or receiving multiple wireless transmissions.

The MTC component 635 may enable operations for low cost or low complexity devices known as machine-type-communication (MTC) devices that may operation using modified procedures in a WLAN. For example, MTC devices may utilize a reduced bandwidth or simplified control signaling.

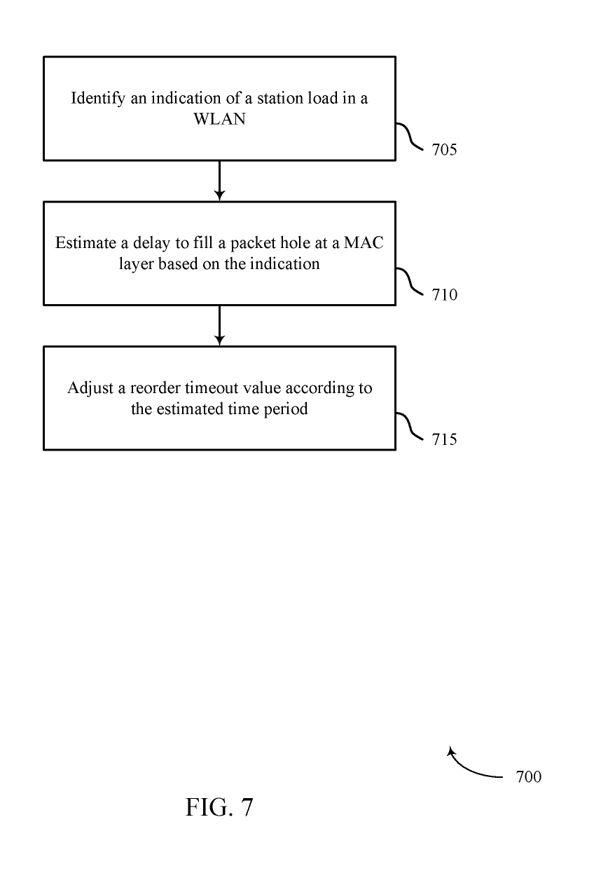

FIG. 7 shows a flowchart illustrating a method 700 for dynamic MAC reception reorder timeout in a crowded wireless local area network in accordance with various aspects of the present disclosure. The operations of method 700 may be implemented by a STA 115 or AP 105 or its components as described with reference to FIGS. 1 and 2. For example, the operations of method 700 may be performed by the packet reorder manager as described herein. In some examples, the STA 115 or base AP 105 may execute a set of codes to control the functional elements of the device to perform the functions described below. Additionally or alternatively, the STA 115 or AP 105 may perform aspects the functions described below using special-purpose hardware.

At block 705, the STA 115 or AP 105 may identify an indication of a station load in a WLAN as described above with reference to FIGS. 0 through 2. In certain examples, the operations of block 705 may be performed by the station load identifying component as described with reference to FIGS. 4 and 5.

At block 710, the STA 115 or AP 105 may estimate a delay to fill a packet hole at a MAC layer based on the indication as described above with reference to FIGS. 0 through 2. In certain examples, the operations of block 710 may be performed by the delay estimation component as described with reference to FIGS. 4 and 5.

At block 715, the STA 115 or AP 105 may adjust a reorder timeout value according to the estimated delay as described above with reference to FIGS. 0 through 2. In certain examples, the operations of block 715 may be performed by the reorder timeout value component as described with reference to FIGS. 4 and 5.

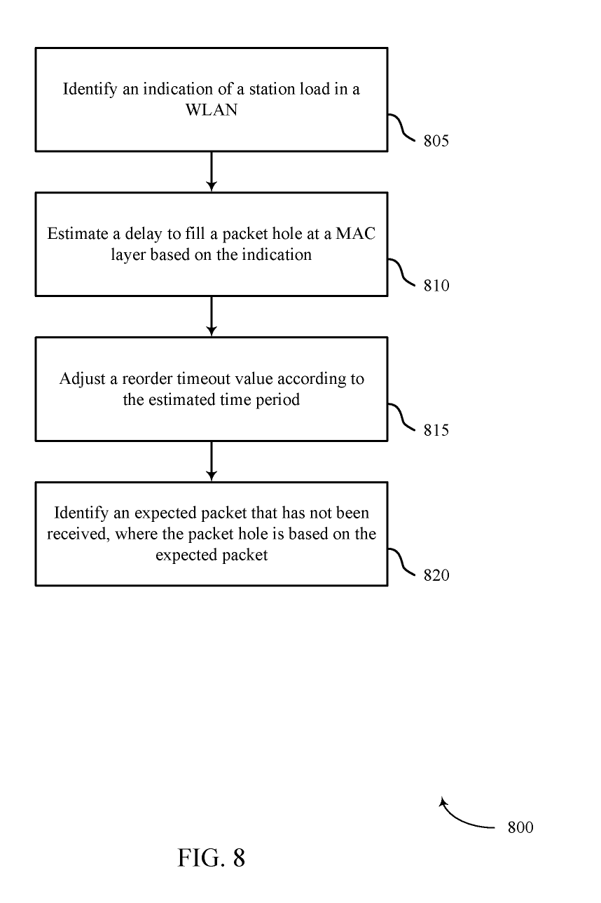

FIG. 8 shows a flowchart illustrating a method 800 for dynamic MAC reception reorder timeout in a crowded WLAN in accordance with various aspects of the present disclosure. The operations of method 800 may be implemented by a STA 115 or AP 105 or its components as described with reference to FIGS. 1 and 2. For example, the operations of method 800 may be performed by the packet reorder manager as described herein. In some examples, the STA 115 or AP 105 may execute a set of codes to control the functional elements of the device to perform the functions described below. Additionally or alternatively, the STA 115 or AP 105 may perform aspects the functions described below using special-purpose hardware.

At block 805, the STA 115 or AP 105 may identify an indication of a station load in a WLAN as described above with reference to FIGS. 0 through 2. In certain examples, the operations of block 805 may be performed by the station load identifying component as described with reference to FIGS. 4 and 5.

At block 810, the STA 115 or AP 105 may estimate a delay to fill a packet hole at a MAC layer based on the indication as described above with reference to FIGS. 0 through 2. In certain examples, the operations of block 810 may be performed by the delay estimation component as described with reference to FIGS. 4 and 5.

At block 815, the STA 115 or AP 105 may adjust a reorder timeout value according to the estimated delay as described above with reference to FIGS. 0 through 2. In certain examples, the operations of block 815 may be performed by the reorder timeout value component as described with reference to FIGS. 4 and 5.

At block 820, the STA 115 or AP 105 may identify an expected packet that has not been received, where the packet hole is based on the expected packet as described above with reference to FIGS. 0 through 2. In certain examples, the operations of block 820 may be performed by the expected packet component as described with reference to FIGS. 4 and 5.

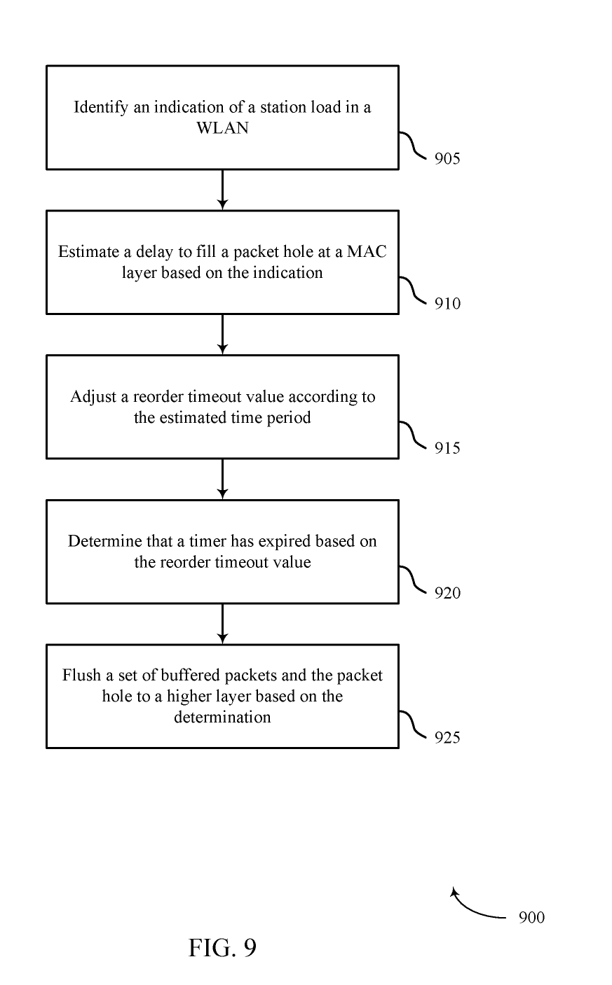

FIG. 9 shows a flowchart illustrating a method 900 for dynamic MAC reception reorder timeout in a crowded WLAN in accordance with various aspects of the present disclosure. The operations of method 900 may be implemented by a STA 115 or AP 105 or its components as described with reference to FIGS. 1 and 2. For example, the operations of method 900 may be performed by the packet reorder manager as described herein. In some examples, the STA 115 or AP 105 may execute a set of codes to control the functional elements of the device to perform the functions described below. Additionally or alternatively, the STA 115 or AP 105 may perform aspects the functions described below using special-purpose hardware.

At block 905, the STA 115 or AP 105 may identify an indication of a station load in a WLAN as described above with reference to FIGS. 0 through 2. In certain examples, the operations of block 905 may be performed by the station load identifying component as described with reference to FIGS. 4 and 5.

At block 910, the STA 115 or AP 105 may estimate a delay to fill a packet hole at a MAC layer based on the indication as described above with reference to FIGS. 0 through 2. In certain examples, the operations of block 910 may be performed by the delay estimation component as described with reference to FIGS. 4 and 5.

At block 915, the STA 115 or AP 105 may adjust a reorder timeout value according to the estimated delay as described above with reference to FIGS. 0 through 2. In certain examples, the operations of block 915 may be performed by the reorder timeout value component as described with reference to FIGS. 4 and 5.

At block 920, the STA 115 or AP 105 may determine that a timer has expired based on the reorder timeout value as described above with reference to FIGS. 0 through 2. In certain examples, the operations of block 920 may be performed by the reorder timeout value component as described with reference to FIGS. 4 and 5.

At block 925, the STA 115 or AP 105 may flush a set of buffered packets and the packet hole to a higher layer based on the determination as described above with reference to FIGS. 0 through 2. In certain examples, the operations of block 925 may be performed by the buffered packet flushing component as described with reference to FIGS. 4 and 5.

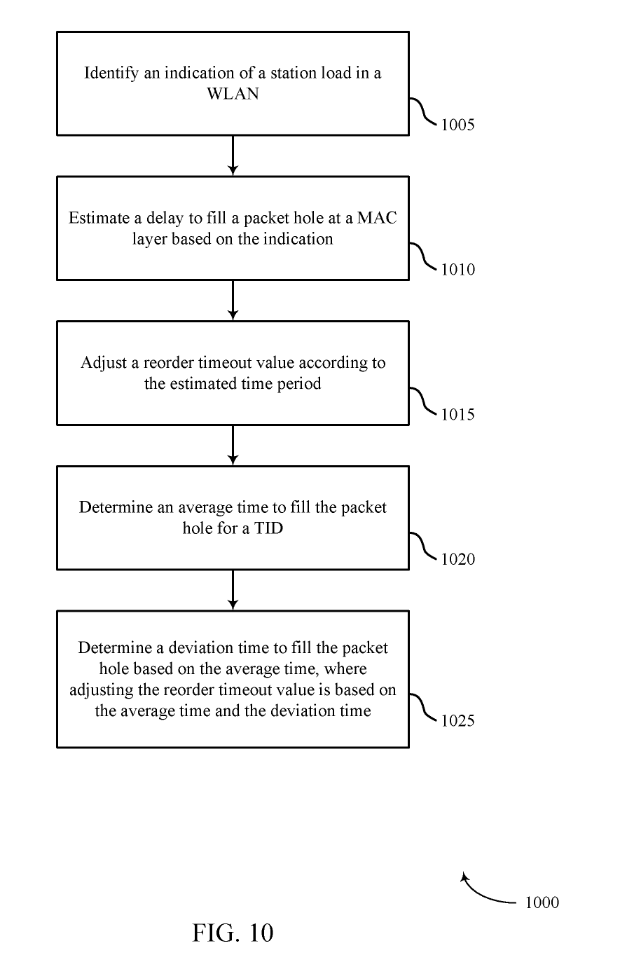

FIG. 10 shows a flowchart illustrating a method 1000 for dynamic MAC reception reorder timeout in a crowded WLAN in accordance with various aspects of the present disclosure. The operations of method 1000 may be implemented by a STA 115 or AP 105 or its components as described with reference to FIGS. 1 and 2. For example, the operations of method 1000 may be performed by the packet reorder manager as described herein. In some examples, the STA 115 or AP 105 may execute a set of codes to control the functional elements of the device to perform the functions described below. Additionally or alternatively, the STA 115 or AP 105 may perform aspects the functions described below using special-purpose hardware.

At block 1005, the STA 115 or AP 105 may identify an indication of a station load in a WLAN as described above with reference to FIGS. 0 through 2. In certain examples, the operations of block 1005 may be performed by the station load identifying component as described with reference to FIGS. 4 and 5.

At block 1010, the STA 115 or AP 105 may estimate a delay to fill a packet hole at a MAC layer based on the indication as described above with reference to FIGS. 0 through 2. In certain examples, the operations of block 1010 may be performed by the delay estimation component as described with reference to FIGS. 4 and 5.

At block 1015, the STA 115 or AP 105 may adjust a reorder timeout value according to the estimated delay as described above with reference to FIGS. 0 through 2. In certain examples, the operations of block 1015 may be performed by the reorder timeout value component as described with reference to FIGS. 4 and 5.

At block 1020, the STA 115 or AP 105 may determine an average time to fill the packet hole for a traffic identifier (TID) as described above with reference to FIGS. 0 through 2. In certain examples, the operations of block 1020 may be performed by the delay estimation component as described with reference to FIGS. 4 and 5.

At block 1025, the STA 115 or AP 105 may determine a deviation time to fill the packet hole based on the average time, where adjusting the reorder timeout value is based on the average time and the deviation time as described above with reference to FIGS. 0 through 2. In certain examples, the operations of block 1025 may be performed by the delay estimation component as described with reference to FIGS. 4 and 5.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for dynamic medium access control reception-reorder timeout in a crowded wireless local area network.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The wireless communications system or systems described herein may support synchronous or asynchronous operation. For synchronous operation, the APs may have similar frame timing, and transmissions from different APs may be approximately aligned in time. For asynchronous operation, the APs may have different frame timing, and transmissions from different APs may not be aligned in time. The techniques described herein may be used for either synchronous or asynchronous operations.

The downlink (DL) transmissions described herein may also be called forward link transmissions while the uplink (UL) transmissions may also be called reverse link transmissions. Each communication link described herein including, for example, wireless communications system 100 of FIG. 1 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., wireless links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

Thus, aspects of the disclosure may provide for dynamic medium access control reception-reorder timeout in a crowded wireless local area network. It should be noted that these methods describe possible implementations, and that the operations and the steps may be rearranged or otherwise modified such that other implementations are possible. In some examples, aspects from two or more of the methods may be combined.

The various illustrative blocks and components described in connection with the disclosure herein may be implemented or performed with a general-purpose processor, a DSP, an ASIC, a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
identifying an indication of a station load in a WLAN;
estimating a delay to fill a packet hole at a MAC layer based at least in part on the indication, wherein the packet hole corresponds to a missing sequence number in a list of packet sequence numbers; and
adjusting a reorder timeout value according to the estimated delay.

2. The method of claim 1, further comprising:
identifying an expected packet that has not been received, wherein the packet hole is based at least in part on the expected packet.

3. The method of claim 1, further comprising:
determining that a timer has expired based at least in part on the reorder timeout value; and
flushing a set of buffered packets and the packet hole to a higher layer based at least in part on the determination.

4. The method of claim 3, further comprising:
determining that a number of bursts received following the packet hole is greater than a threshold, wherein flushing the set of buffered packets and the packet hole is based at least in part on the determination that the number of bursts received following the packet hole is greater than the threshold.

5. The method of claim 1, further comprising:
determining an average time to fill the packet hole for a traffic identifier (TID); and
determining a deviation time to fill the packet hole based at least in part on the average time, wherein adjusting the reorder timeout value is based at least in part on the average time and the deviation time.

6. The method of claim 1, further comprising:
identifying a minimum value and a maximum value, wherein adjusting the reorder timeout value is based at least in part on the minimum value or the maximum value.

7. The method of claim 1, further comprising:
identifying an access category, wherein the reorder timeout value is based at least in part on the access category.

8. The method of claim 1, wherein adjusting the reorder timeout value comprises: increasing the reorder timeout value if the station load is above a threshold or decreasing the reorder timeout value if the station load is below the threshold.

9. The method of claim 1, further comprising:
receiving a message from an access point, the message comprising the indication of the station load.

10. An apparatus for wireless communication comprising:
a station load identifying component for identifying an indication of a station load in a WLAN;
a delay estimation component for estimating a delay to fill a packet hole at a MAC layer based at least in part on the indication, wherein a packet hole corresponds to a hole in a list of sequence numbers;
a packet request timer for reordering a missing packet; and
a reorder timeout value component for adjusting a reorder timeout value of the packet request timer according to the estimated delay.

11. The apparatus of claim 10, further comprising:
an expected packet component for identifying an expected packet that has not been received, wherein the packet hole is based at least in part on the expected packet.

12. The apparatus of claim 10, further comprising:
the reorder timeout value component for determining that a timer has expired based at least in part on the reorder timeout value; and
a buffered packet flushing component for flushing a set of buffered packets and the packet hole to a higher layer based at least in part on the determination.

13. The apparatus of claim 12, further comprising:
the reorder timeout value component for determining that a number of bursts received following the packet hole is greater than a threshold, wherein flushing the set of buffered packets and the packet hole is based at least in part on the determination that the number of bursts received following the packet hole is greater than the threshold.

14. The apparatus of claim 10, further comprising:
the reorder timeout value component for determining an average time to fill the packet hole for a traffic identifier (TID); and
determining a deviation time to fill the packet hole based at least in part on the average time, wherein adjusting the reorder timeout value is based at least in part on the average time and the deviation time.

15. The apparatus of claim 10, further comprising:
the reorder timeout value component for identifying a minimum value and a maximum value, wherein adjusting the reorder timeout value is based at least in part on the minimum value or the maximum value.

16. The apparatus of claim 10, further comprising:
the reorder timeout value component for identifying an access category, wherein the reorder timeout value is based at least in part on the access category.

17. The apparatus of claim 10, wherein adjusting the reorder timeout value comprises: increasing the reorder timeout value if the station load is above a threshold or decreasing the reorder timeout value if the station load is below the threshold.

18. The apparatus of claim 10, further comprising:
a receiver for receiving a message from an access point, the message comprising the indication of the station load.

19. An apparatus for wireless communication, comprising:
a processor;
memory in electronic communication with the processor; and
instructions stored in the memory and operable, when executed by the processor, to cause the apparatus to:
identify an indication of a station load in a WLAN;
estimate a delay to fill a packet hole at a MAC layer based at least in part on the indication, wherein a packet hole corresponds to a hole in a list of sequence numbers; and
adjust a reorder timeout value according to the estimated delay.

20. The apparatus of claim 19, wherein the instructions are operable to cause the processor to:
identify an expected packet that has not been received, wherein the packet hole is based at least in part on the expected packet.

21. The apparatus of claim 19, wherein the instructions are operable to cause the processor to:
determine that a timer has expired based at least in part on the reorder timeout value; and
flush a set of buffered packets and the packet hole to a higher layer based at least in part on the determination.

22. The apparatus of claim 21, wherein the instructions are operable to cause the processor to:
determine that a number of bursts received following the packet hole is greater than a threshold, wherein flushing the set of buffered packets and the packet hole is based at least in part on the determination that the number of bursts received following the packet hole is greater than the threshold.

23. The apparatus of claim 19, wherein the instructions are operable to cause the processor to:
determine an average time to fill the packet hole for a traffic identifier (TID); and
determine a deviation time to fill the packet hole based at least in part on the average time, wherein adjusting the reorder timeout value is based at least in part on the average time and the deviation time.

24. The apparatus of claim 19, wherein the instructions are operable to cause the processor to:
identify a minimum value and a maximum value, wherein adjusting the reorder timeout value is based at least in part on the minimum value or the maximum value.

25. The apparatus of claim 19, wherein the instructions are operable to cause the processor to:
identify an access category, wherein the reorder timeout value is based at least in part on the access category.

26. The apparatus of claim 19, wherein the instructions are operable to cause the processor to adjust the reorder timeout value are further operable to cause the processor to
increase the reorder timeout value if the station load is above a threshold or decreasing the reorder timeout value if the station load is below the threshold.

27. The apparatus of claim 19, wherein the instructions are operable to cause the processor to
receive a message from an access point, the message comprising the indication of the station load.

28. A non-transitory computer-readable medium storing code for wireless communication, the code comprising instructions executable to:
identify an indication of a station load in a WLAN;
estimate a delay to fill a packet hole at a MAC layer based at least in part on the indication, wherein a packet hole corresponds to a hole in a list of sequence numbers; and
adjust a reorder timeout value according to the estimated delay.

29. The non-transitory computer-readable medium of claim 28, wherein the instructions are executable to:
identify an expected packet that has not been received, wherein the packet hole is based at least in part on the expected packet.

30. The non-transitory computer-readable medium of claim 28, wherein the instructions are executable to:
determine that a timer has expired based at least in part on the reorder timeout value; and
flush a set of buffered packets and the packet hole to a higher layer based at least in part on the determination.
